(19) United States
(12) Patent Application Publication
(10) Pub. No.: US 2026/0067650 A1
(43) Pub. Date: Mar. 5, 2026

(54) METHOD AND APPARATUS FOR TRANSMITTING DATA, AND COMMUNICATION DEVICE

(71) Applicant: VIVO MOBILE COMMUNICATION CO., LTD., Guangdong (CN)

(72) Inventors: Hui Jin, Guangdong (CN); Xiaobo Wu, Guangdong (CN); Weiwei Chong, Guangdong (CN)

(73) Assignee: VIVO MOBILE COMMUNICATION CO., LTD., Guangdong (CN)

(21) Appl. No.: 19/377,670

(22) Filed: Nov. 3, 2025

Related U.S. Application Data
(63) Continuation of application No. PCT/CN2024/090250, filed on Apr. 28, 2024.

(30) Foreign Application Priority Data
May 4, 2023 (CN) 202310491030.6

(51) Int. Cl. H04W 4/38; H04W 76/12

(52) U.S. Cl. CPC H04W 4/38; H04W 76/12

(57) ABSTRACT

Disclosed in the present application are a method and apparatus for transmitting data, and a communication device. The method for transmitting data according to embodiments of the present application includes: sending a container to a second device by a first device, where the container includes sensing data of a sensing service.

### CROSS-REFERENCE TO RELATED APPLICATIONS

The present application is a Bypass continuation application of PCT International Application No. PCT/CN2024/090250 filed on Apr. 28, 2024, which claims the priority of the Chinese Patent Application No.202310491030.6 filed in China on May 4, 2023, the entire content of which is hereby incorporated by reference.

### TECHNICAL FIELD

The present application belongs to the technical field of communication, and in particular to a method and apparatus for transmitting data, and a communication device.

### BACKGROUND

The 3rd generation partnership project (3GPP) standard is responsible for standardizing sensing data between a radio access network (RAN) and a sensing function (SF), that is, standardizing how to transfer specific sensing data through specific parameters. The 3GPP currently supports standardizing transmission of sensing data of a specific sensing service only, that is, in a solution of related art, sensing data of a specific sensing service can be transmitted only, and there is no related solution on how to transmit sensing data of a customized sensing service other than the foregoing specific sensing service.

### SUMMARY

Embodiments of the present application provide a method and apparatus for transmitting data, and a communication device.

According to a first aspect, a method for transmitting data is provided. The method includes:

sending a container to a second device by a first device, where the container includes sensing data of a sensing service.

According to a second aspect, a method for transmitting data is provided. The method includes:

obtaining, by a second device, a container sent by a first device, where the container includes sensing data of a sensing service.

According to a third aspect, an apparatus for transmitting data is provided. The apparatus includes:

a first sending module configured to send a container to a second device, where the container includes sensing data of a sensing service.

According to a fourth aspect, an apparatus for transmitting data is provided. The apparatus includes:
a first obtaining module configured to obtain a container sent by a first device, where the container includes sensing data of a sensing service.

According to a fifth aspect, a first device (terminal or network device) is provided. The first device includes a processor and a memory. The memory stores a program or instructions runnable on the processor. The program or the instructions, when executed by the processor, implement steps of the method according to the first aspect.

According to a sixth aspect, a first device (terminal or network device) is provided. The first device includes a processor and a communication interface. The communication interface is configured to send a container to a second device. The container includes sensing data of a sensing service.

According to a seventh aspect, a second device (network device) is provided. The second device includes a processor and a memory. The memory stores a program or instructions runnable on the processor. The program or the instructions, when executed by the processor, implement steps of the method according to the second aspect.

According to an eighth aspect, a second device (network device) is provided. The second device includes a processor and a communication interface. The communication interface is configured to obtain a container sent by a first device. The container includes sensing data of a sensing service.

According to a ninth aspect, a readable storage medium is provided. The readable storage medium stores a program or an instruction. The program or the instruction, when executed by a processor, implement steps of the method according to the first aspect or implement steps of the method according to the second aspect.

According to a tenth aspect, a system for transmitting data is provided. The system includes a first device and a second device. The first device may be configured to perform steps of the method according to the first aspect. The second device may be configured to perform steps of the method according to the second aspect.

According to an eleventh aspect, a chip is provided. The chip includes a processor and a communication interface. The communication interface is coupled to the processor. The processor is configured to execute a program or instructions, to implement the method according to the first aspect or implement the method according to the second aspect.

According to a twelfth aspect, a computer program/program product is provided. The computer program/program product is stored in a storage medium. The computer program/program product is executed by at least one processor to implement steps of the method according to the first aspect or the second aspect.

### BRIEF DESCRIPTION OF THE DRAWINGS

FIG. 1 is a structural diagram of a communication system to which an embodiment of the present application applicable;

FIG. 2 is a schematic diagram of a transmission architecture of sensing data;

FIG. 3 is a first schematic flowchart of a method for transmitting data according to an embodiment of the present application;

FIG. 4 is a first schematic interaction diagram of a method for transmitting data according to an embodiment of the present application;

FIG. 5 is a second schematic interaction diagram of a method for transmitting data according to an embodiment of the present application;

FIG. 6 is a second schematic flowchart of a method for transmitting data according to an embodiment of the present application;

FIG. 7 is a first schematic module diagram of an apparatus for transmitting data according to an embodiment of the present application;

FIG. 8 is a second schematic module diagram of an apparatus for transmitting data according to an embodiment of the present application;

FIG. 9 is a structural block diagram of a communication device according to an embodiment of the present application;

FIG. 10 is a structural block diagram of a terminal according to an embodiment of the present application;

FIG. 11 is a first structural block diagram of a network device according to an embodiment of the present application; and

FIG. 12 is a second structural block diagram of a network device according to an embodiment of the present application.

### DETAILED DESCRIPTION

The technical solutions in embodiments of the present application are clearly described in the following with reference to the accompanying drawings in the embodiments of the present application. Apparently, the described embodiments are some embodiments rather than all embodiments of the present application.

The terms “first,” “second” and so forth in the present application are used for distinguishing between similar objects, instead of describing a particular order or sequential order. It should to be understood that terms used in this way are exchangeable in a proper case, such that the embodiments of the present application can be implemented in an order different from the order shown or described herein. Objects distinguished by “first” and “second” are usually of one type, and the number of the objects is not limited. For example, one or more first objects may be provided. Furthermore, “or” in the present application indicates at least one of connected objects. For example, “A or B” covers three solutions, that is, solution 1: including A and excluding B; solution 2: including B and excluding A; and solution 3: including both A and B. The character “/” generally indicates that the associated objects are in an “or” relationship.

The term “indication” in the present application may be a direct indication (or explicit indication) or an indirect indication (or implicit indication). The direct indication may be understood as that a sender explicitly informs a receiver of specific information, operations to be performed or request results, etc. in the indication sent by the sender. The indirect indication may be understood as that a receiver determines corresponding information according to the indication sent by a sender, or performs judgment and determines operations to be performed or request results, etc. according to judgment results.

It is worth pointing out that the technologies described in the embodiments of the present application are not limited to a long term evolution (LTE)/long term evolution-advanced (LTE-A) system, and may further be applied to other wireless communication systems such as code division multiple access (CDMA), time division multiple access (TDMA), frequency division multiple access (FDMA), orthogonal frequency division multiple access (OFDMA), single-carrier frequency division multiple access (SC-FDMA), or other systems. The terms “system” and “network” in the embodiments of the present application are often used interchangeably. The technology described can be applied to the systems and radio technologies mentioned above, and can also be applied to other systems and radio technologies. A new radio (NR) system is described below as an example, and the term NR is used in most of the following description. Nevertheless, the technologies may alternatively be applied to a system other than the NR system, such as a 6th generation (6G) communication system.

FIG. 1 shows a block diagram of a wireless communication system to which the embodiments of the present application are applicable. The wireless communication system includes a terminal 11 and a network device 12. The terminal 11 may be a terminal device such as a mobile phone, a tablet personal computer, a laptop computer, a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, a flight vehicle, vehicle user equipment (VUE), ship user equipment, a pedestrian user equipment (PUE), a smart home (a home device having a wireless communication function, such as a refrigerator, a television, a washing machine, or furniture), a game console, a personal computer (PC), a teller machine, or a self-service machine. The wearable device includes: a smart watch, a smart bracelet, a smart headset, smart glasses, smart jewelry (a smart bracelet, a smart chain bracelet, a smart ring, a smart necklace, a smart ankle bangle, a smart ankle chain, and the like), a smart wristband, smart clothing, and the like. The vehicle user equipment may alternatively be referred to as a vehicle user terminal, a vehicle user controller, a vehicle user module, a vehicle user component, a vehicle user chip, a vehicle user unit, or the like. Besides the above terminal devices, the terminal may alternatively be a chip in a terminal, for example, a modem chip or a system on chip (SoC). It should be noted that a specific type of the terminal 11 is not limited in the embodiments of the present application. The network device 12 may include an access network device or a core network device. The access network device may alternatively be referred to as a radio access network (RAN), a radio access network function, or a radio access network unit. The access network device may include a base station, a wireless local area network (WLAN) access point (AP), a wireless fidelity (WiFi) node, or the like. The base station may be referred to as a node B (NB), an evolved mode B (eNB), the next generation node B (gNB), a new radio node B (NR Node B), an access point, a relay base station (RBS), a serving base station (SBS), a base transceiver station (BTS), a radio base station, a radio transceiver, a basic service set (BSS), an extended service set (ESS), a home node B (HNB), a home evolved node B, a transmission reception point (TRP) or some other suitable terms in the field as long as the same technical effect is achieved. The base station is not limited to a specific technical word. It is to be noted that in the embodiments of the present application, introduction is made only taking the base station in the NR system as an example, and the specific type of the base station is not limited.

The core network device may include, but is not limited to, at least one of the following: a core network node, a core network function, a mobility management entity (MME), an access and mobility management function (AMF), a session management function (SMF), a user plane function (UPF), a policy control function (PCF), a policy and charging rules function (PCRF), an edge application server discovery function (EASDF), unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), or the like. It should be noted that the core network device in the NR system is used only as an example for description in the embodiments of the present application, and a specific type of the core network device is not limited.

To enable those skilled in the art to better understand the embodiments of the present application, the following description is provided first.

### 1. Integrated Sensing and Communication

In related art, wireless communication and radar sensing (C&S) are developed in parallel, but have limited intersection. The wireless communication and the radar sensing share a lot in common in terms of signal processing algorithms, devices, and, to some extent, system architectures. In recent years, the two systems receive more and more attention from researchers on coexistence, cooperation, and joint design.

Earlier, people have intensively researched an issue of coexistence of a communication system and a radar system. The research focuses on developing an effective interference management technology, such that two independently deployed systems can smoothly run without interference in each other. Although the radar system and the communication system may be at a same location or even physically integrated, they transmit two different signals in a time/frequency domain. The radar system and the communication system share same resources through cooperation, so as to reduce interference to each other when working simultaneously to the greatest extent. Corresponding measures include beamforming, cooperative spectrum sharing, primary and secondary spectrum sharing, dynamic coexistence, etc. However, effective interference cancellation usually has strict requirements on mobility of nodes and information exchange between nodes. Thus improvement of spectrum efficiency is actually limited. Since interference in a coexisting system is caused by transmitting two independent signals, it is natural to ask whether communication and radar sensing can be simultaneously performed by using one transmitted signal. The radar system usually uses specially designed waveforms, such as a short pulse and a chirp, which can implement high-power radiation and simplify processing of a receiver. However, these waveforms are not necessary for radar detection. For example, passive radar or passive sensing uses different radio signals as sensing signals.

Machine learning, and in particular, a deep learning technology further promotes potential of non-dedicated radio signals for radar sensing. With these technologies, conventional radars are being developed towards a more universal wireless sensing. The wireless sensing herein may widely refer to retrieving information from a received radio signal, rather than modulating communication data of a signal on a transmitter. For wireless sensing related to a location of a sensing objective, dynamic parameters such as a reflection delay, an angle of arrival (AoA), an angle of departure (AoD), and Doppler of a target signal may be estimated through a common signal processing method. Physical features of a sensing objective may be implemented by measuring a device, an object, or a live intrinsic mode signal. The two sensing manners may be respectively referred to as sensing parameter estimation and mode identification. In this sense, the wireless sensing refers to a more universal sensing technology and application using a radio signal.

The integrated sensing and communication (ISAC) has potential to integrate the wireless sensing into large-scale mobile networks, to become perceptive mobile networks (PMNs) herein. The PMN may evolve from a current 5th-generation (5G) mobile network, and is expected to become a ubiquitous wireless sensing network and further provide stable and high-quality mobile communication services. The PMN can be built on a mobile network infrastructure of the related art, and does not need to significantly change a network structure and a device. It releases a maximum capability of a mobile network, and avoids overwhelming infrastructure costs to independently construct a new wide-area wireless sensing network. With expansion of coverage, many new applications are expected to be implemented by combining communication and sensing capabilities. The perceptive mobile network can provide both communication and wireless sensing services, and may become a pervasive wireless sensing solution due to its large broadband coverage and powerful infrastructure. Jointly coordinated communication and sensing capabilities of the perceptive mobile network improve production of the society, and help generate a large number of new applications that cannot be effectively implemented by a sensor network of the related art. Some early work of performing passive sensing by using a movement signal has proven the potential of the perceptive mobile network, for example, traffic monitoring, weather forecasting, and rainfall remote sensing based on a radio signal of a global system for mobile communications (GSM). The perceptive mobile network may be widely applied to communication and sensing in the fields of traffic, communication, energy, precise agriculture, and security. Solutions of the related art are either not feasible or have low efficiency. It may further provide complementary sensing capabilities for a sensor network of the related art, have unique day and night operation functions, and can penetrate fog, tree leaves, and even solid objects.

### 2. Transmission Method of Sensing and Communication Service Data

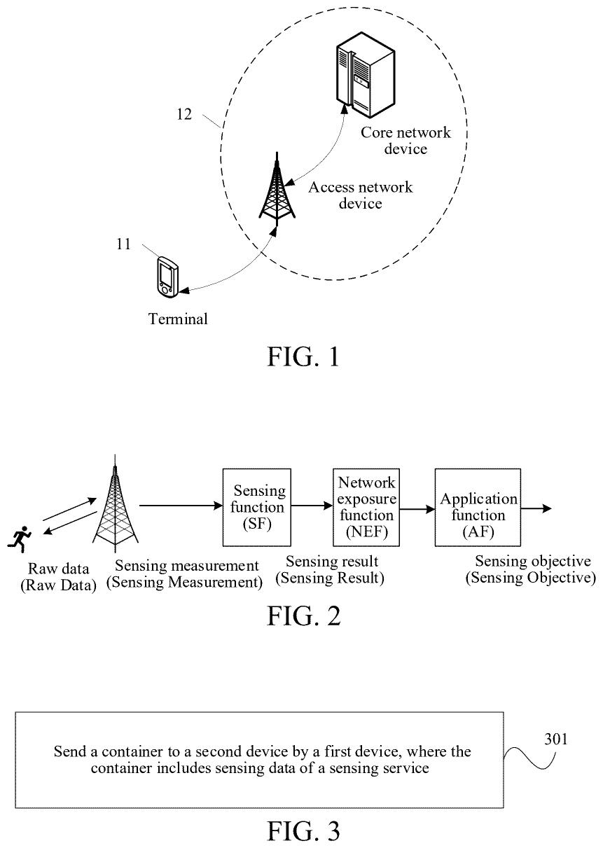

In an architecture shown in FIG. 2, a sensing function (SF) is a network element newly added for a sensing and communication service, and is responsible for managing the sensing and communication service and processing sensing and communication data. SF may be one network element, which is responsible for a user plane and a control plane; or may be two network elements, that is, a sensing function control plane (SF-C) and a sensing function user plane (SF-U) that are separated. Illustratively, the sensing measurement includes delay, Doppler, angle, strength, and a multidimensional combination of them. A sensing result refers to a result obtained after the SF processes the Sensing Measurement, for example, intermediate processing results such as speed, distance, orientation, acceleration, location, track, and action. A sensing objective is a final result obtained by an application function (IF), for example, a car violation or road congestion.

A method for transmitting data according to the embodiments of the present application is described in detail below through some embodiments and application scenarios with reference to the accompanying drawings.

As shown in FIG. 3, an embodiment of the present application provides a method for transmitting data. The method includes:

Step 301: A first device sends a container to a second device, where the container includes sensing data of a sensing service.

Optionally, the first device is a radio access network device (for example, a base station) or a terminal. The second device is a sensing function network element device, that is, an SF network element device. Or, the second device is a network element device having a sensing function, for example, an SMF or a location management function (LMF) having a sensing function.

The sensing data in the embodiment of the present application is data corresponding to the sensing measurement. For example, when the sensing measurement is a delay, the sensing data is delay data detected by a base station. When the sensing measurement is signal strength, the sensing data is signal strength data.

In the embodiment of the present application, the first device sends the container to the second device. The container includes the sensing data of the sensing service. According to the solution, when an operator or a manufacturer has a customization requirement for a sensing service, sensing data corresponding to the sensing service satisfying the customization requirement can be transmitted through the container.

Optionally, the first device sends the container to the second device, which includes at least one of the following:

the first device sends an Internet protocol (IP) packet to the second device, where the IP packet includes the container;
the first device sends a general packet radio service (GPRS) tunneling protocol (GTP) packet to the second device, where the GTP packet includes the container;
the first device sends a new radio sensing protocol (NRSP) packet to the second device, where the NRSP packet includes the container,
it should be noted that the NRSP is described by using a 5G communication system as an example, in a 4G communication system, the NRSP may be a long term evolution (LTE) sensing protocol (LSP), in a 6G communication system, the NRSP may be a 6G sensing protocol (6GSP), and 6G may vary according to a name of 6G, for example, when the name of 6G is next general (NG), the 6GSP is an NGSP; or
the first device sends a non access stratum (NAS) message to the second device, where the NAS message includes the container.

In the embodiment of the present application, the container may be included in an IP packet, a GTP packet, an NRSP packet, or an NAS message. The container is sent by using the IP packet, the GTP packet, the NRSP packet, or the NAS message.

Optionally, the first device sends the container to the second device as follows:

the first device sends a private message (PrivateMessage) to the second device. The private message includes the container. The container may be a private information element container (PrivateIE-Container).

Optionally, the first device sends the container to the second device as follows:
the first device sends one container to the second device, where one container includes at least two sensing service identifiers and sensing data of a sensing service corresponding to each sensing service identifier;
or, the first device sends N1 containers and N1 sensing service identifiers to the second device, where each of the N1 containers includes sensing data of one sensing service, the N1 sensing service identifiers have a one-to-one correspondence with the N1 containers, and N1 is a positive integer;
or, the first device sends N2 containers to the second device, where each of the N2 containers includes one sensing service identifier and sensing data of a sensing service corresponding to the sensing service identifier, and N2 is a positive integer.

In the embodiment of the present application, one container may be carried in the IP packet, the GTP packet, the NRSP packet, or the NAS message. The one container includes at least two sensing service identifiers and sensing data of a sensing service corresponding to each sensing service identifier. Or, N1 containers and N1 sensing service identifiers are carried in the IP packet, the GTP packet, the NRSP packet, or the NAS message. Or, N2 containers are carried in the IP packet, the GTP packet, the NRSP packet, or the NAS message.

Optionally, the sensing data of the sensing service includes data corresponding to a sensing measurement of the sensing service. The sensing measurement includes a common sensing measurement and an additional sensing measurement; or the sensing measurement of the sensing service includes an additional sensing measurement.

In the embodiment of the present application, the common sensing measurement may be a standardized sensing measurement. The additional sensing measurement may be an unstandardized sensing measurement. For example, the common sensing measurement is a sensing measurement that is already standardized in 3GPP. The additional sensing measurement is a sensing measurement that is not standardized in 3GPP. Or, the common sensing measurement may be a measurement transferred between the first device and the second device in a predefined transmission method. For example, the first device may transfer data corresponding to the sensing measurement through a predefined parameter. When obtaining the data carried in the parameter, the second device may obtain the sensing measurement corresponding to the data.

Optionally, in a case that the sensing measurement of the sensing service includes the additional sensing measurement, the method further includes:

the first device sends data corresponding to the common sensing measurement of the sensing service and the service identifier corresponding to the sensing service to the second device through a predefined parameter.

It should be noted that the service identifier in the present application is used for identifying a sensing service, and may alternatively be referred to as a sensing service identifier, a sensing service identifier, a sensing task identifier, a sensing objective identifier, a sensing identifier (Sensing ID), or an identifier. The following is the same, which is not described herein in detail.

In the embodiment of the present application, the standardized common sensing measurement is transmitted through the predefined parameter. The common sensing measurement is associated with the additional sensing measurement by using the identifier corresponding to the sensing service. That is, a common sensing measurement and an additional sensing measurement of a same sensing service correspond to a same service identifier.

Optionally, the predefined parameter is a parameter agreed on or specified by a protocol. For example, parameter 1 specified by a protocol is used for Doppler data transmission, and parameter 2 specified by a protocol is used for transmission of signal strength data.

Optionally, the first device sends the container to the second device as follows:
the first device negotiates with the second device to determine a transmission method of the sensing data of the sensing service; and
the first device sends the container to the second device in a case of determining to send the sensing data of the sensing service through the container.

In the embodiment of the present application, the sensing data transmission method includes: the sensing data is transmitted through a predefined parameter or through a container. The first device and the second device first negotiate to determine a transmission method of the sensing data. In a case of determining that the transmission method of the sensing data is to send the sensing data of the sensing service through the container, the first device sends the container to the second device.

In an optional implementation, the first device negotiates with the second device to determine a transmission method of the sensing data of the sensing service as follows:
the first device obtains a first message sent by the second device, where the first message includes a transmission method of sensing data requested or supported by the second device; and
the first device sends a second message to the second device, where the second message includes the transmission method, that is determined by the first device according to the first message, of the sensing data of the sensing service.

Optionally, the first message may be a sensing service request. After receiving a command for performing a sensing service requirement, the second device sends the sensing service request to the first device. The sensing service requirement may be triggered by an application function, may be triggered by the second device, or may be triggered by the first device or the terminal.

Optionally, in a case that the first message includes the transmission method of sensing data requested by the second device, the second device may carry at least one transmission method, that can be used for transmitting the sensing data, determined by the second device. In a case that the first message includes the transmission method of sensing data supported by the second device, the second device may carry at least one transmission method, that can be used for transmitting the sensing data, supported by the second device.

Optionally, in a case that the transmission method, in the first message, of sensing data requested or supported by the second device is to transmit sensing data through a container, the first message further includes a sensing measurement indicated by the second device and corresponding to the sensing data transmitted through a sensing and communication container.

Optionally, the first device sends the second message to the second device as follows:

the second message is sent to the second device in a case that the first device supports the transmission method of sensing data requested or supported by the second device. The second message is used for indicating that the determined transmission method of the sensing data of the sensing service is the transmission method of sensing data requested or supported by the second device, or the second message is used for indicating that the determined transmission method of the sensing data of the sensing service is one of the transmission methods of sensing data requested or supported by the second device. For example, in a case that the second device requests or supports two transmission methods of sensing data, the second device determines a final transmission method.

Optionally, the first message further includes a sensing service performed by the second device or a service identifier corresponding to a sensing service performed by the second device.

Optionally, in a case that the first message does not include the service identifier corresponding to the sensing service performed by the second device, the second message includes the service identifier corresponding to the sensing service performed by the second device.

In the embodiment of the present application, the service identifier corresponding to the sensing service may be allocated by the first device, or may be allocated by the second device. For example, in a case that the service identifier corresponding to the sensing service may be allocated by the second device, the first message includes the service identifier. Or, in a case that the service identifier corresponding to the sensing service may be allocated by the first device, the second message includes the service identifier. The service identifier is allocated by the first device to the sensing service.

Optionally, the implementation further includes:

the first device sends at least one of the following to the second device:

a supported sensing service;
a supported sensing measurement; or
a supported sensing data transmission method.

The sensing data transmission method includes: the sensing data is transmitted through a predefined parameter or through a container.

In the implementation, the first device may send the foregoing information by registering a sensing service supported by the first device in the second device. Specifically, registration information includes at least one of the following:
a supported sensing measurement;
a supported transmission method of sensing data;
vender information of the first device, for example, a vender identifier of the first device; or
token information supported by the first device.

The sensing measurement in the embodiment of the present application includes at least one of delay, Doppler, angle, or strength. The sensing measurement may alternatively be understood as a sensing parameter, a sensing input, or a sensing vector.

The second device records, according to the registration information, a sensing service supported by each first device or a transmission method of sensing data supported by each first device. After receiving a command for performing a sensing service requirement, the second device selects a first device according to the transmission method of sensing data or the sensing service supported by each first device, and sends the first message to the selected first device.

Optionally, a registration message may alternatively be a notification message or a service request message.

Optionally, the first message further includes at least one of the following:
a sensing measurement that needs to be reported by the first device;
vender information of the second device; or
token information of the second device.

Optionally, the first device sends the second message to the second device as follows:

the first device sends the second message to the second device in a case that the transmission method of sensing data requested by the second device is to transmit sensing data through a container, and the vender information or the token information satisfies a preset condition.

Optionally, the foregoing preset condition includes: a vender of the second device is a vender that is appointed in advance and can transmit the sensing data to the first device through the container, or the token information of the second device is the same as or matches the token information stored or possessed by the first device.

The implementation will be described below in combination with an embodiment.

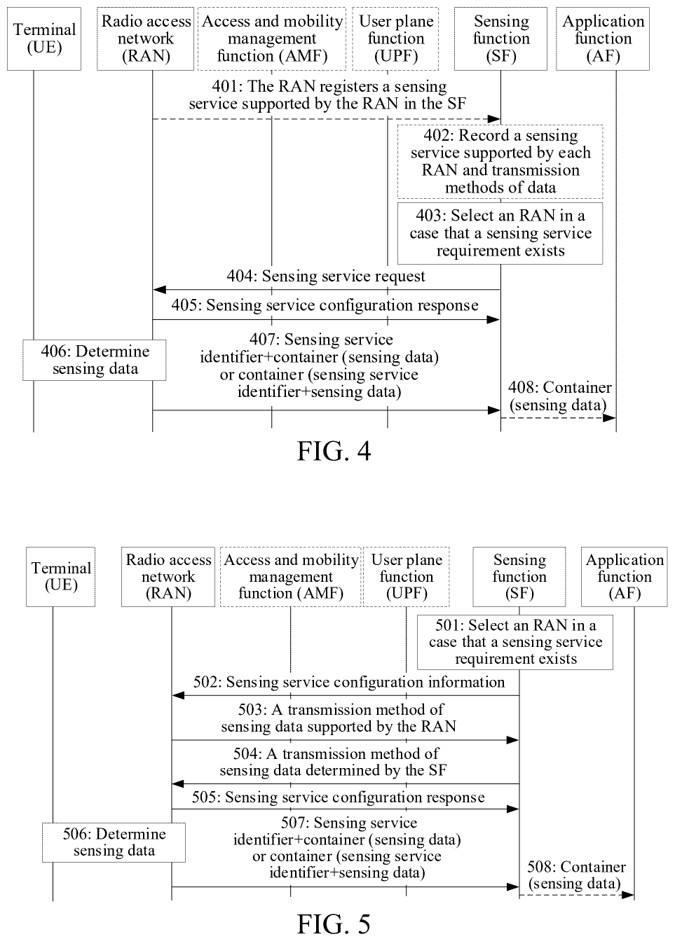

In the embodiment, the first device is an RAN, and the second device is an SF. As shown in FIG. 4, the embodiment includes:

Step 401: Each RAN registers a sensing service supported by the RAN in an SF, where the registration information includes the following information:

a supported transmission method of sensing data.

Optionally, the registration information may further include at least one of the following:
a supported sensing measurement;
a vender ID to which the RAN belongs, or
a token supported by the RAN.

Step 401 is optional.

Step 402: The SF records a sensing service supported by each RAN and supported transmission methods of sensing data.

Step 402 is optional.

Step 403: The SF receives a command for performing a sensing service requirement and selects an RAN according to the sensing service requirement.

The requirement may be an AF trigger, an SF trigger, an RAN trigger, or a UE trigger.

In a case of performing Step 401 and Step 402, the SF selects an RAN according to capabilities (a supported sensing service and a supported transmission method of sensing data) of each RAN.

Step 404: The SF sends a sensing service request to the selected RAN.

The sensing service request includes the following information:
a performed sensing service or a service identifier corresponding to a sensing service; and
a transmission method of sensing data requested or supported by the SF.

In a case that the transmission method of sensing data requested or supported by the SF is to transmit sensing data through a container (for example, to transmit sensing data corresponding to an additional measurement through the container), the SF further indicates sensing data corresponding to which measurement is transmitted through the container.

Optionally, the sensing service request further includes at least one of the following:
a sensing measurement to be reported by the RAN;
a vender ID of the SF, that is, vender information of the SF; or
token information of the SF, that is, a token owned by the SF.

Step 405: The RAN determines to reply with a sensing service configuration response according to whether a sensing service corresponding to the sensing service request and the transmission method of the sensing data are supported, and the sensing configuration service response includes an acknowledgement message or a rejection message.

It is determined to reply with the acknowledgement message (that is, the second message) in a case that the RAN supports the sensing service corresponding to the sensing service request and the transmission method of the sensing data. It is determined to reply with the rejection message in a case that the RAN does not support the sensing service corresponding to the sensing service request and the transmission method of the sensing data.

In a case that the sensing request carries the vender ID or the token information, the RAN further determines whether to support transmission through the container (or to perform customized transmission or private transmission).

Step 406: The RAN collects and processes the sensing data.

Step 407: The RAN sends the obtained sensing data to the SF.

For the common sensing measurement, when sending the sensing data to the SF, the RAN sends the sensing data through the predefined parameter.

The additional sensing measurement is transmitted through a container.

Specifically, using a container for transmission includes the following two solutions:

Solution 1: Data of a plurality of sensing services of the RAN is transmitted through one container. Different sensing services are distinguished from each other by using a service identifier of each sensing service (sensing Service id) and sensing data in the container.

Solution 2: Each sensing service corresponds to one independent container, and is transmitted in a manner of sensing Service id+container, or transmitted by carrying the sensing Service id and the sensing data in the container.

For a specific sensing service, sensing data corresponding to some sensing measurements may be transmitted through the predefined parameter, sensing data corresponding to the additional sensing measurements is transmitted through a container, and the two parts of data are associated by using the sensing Service id.

For example, sensing measurements corresponding to a sensing service are X1 and X2. To improve precision, sensing measurements X3 and X4 are customized.

For a common RAN device, only X1 and X2 need to be transmitted through a predefined message format.

For a customized RAN device, based on transferring X1 and X2 through the predefined message format, X3 and X4 are further transferred through a container. The SP associates X1, X2, X3, and X4 according to the sensing Service id, and processes the X1, X2, X3, and X4 together.

The container may be specifically included in a GTP message, an IP packet, an NRSP packet, or an NAS message.

For an RAN-SF architecture, the container is included in a GTP message, an IP packet, or an NRSP packet.

For an RAN-UPF-SF architecture, the container is included in an IP packet or an NRSP packet.

For an RAN-AMF-SF architecture, the container is included in NAS signaling or an NRSP packet.

Step 408: In a case that the sensing service is a sensing service requested by the AR, the SR sends the sensing data to the AR through another container.

In Step 404, an example in which the sensing service id is allocated by the SF is used for description, or the sensing service id may be allocated by the RAN. In this case, no sensing service id is carried in Step 404, and the RAN allocates the sensing service id after receiving Step 404 and sends the sensing service id to the SF in Step 405.

It should be noted that between Step 403 and Step 404, the SF may first request the RAN for a transmission method of sensing data supported by the SF, a vender ID, or a token. The SF sends Step 404 according to information obtained from the RAN. This step may replace step 401 and step 402 described above.

In another optional implementation, the first device negotiates with the second device to determine a transmission method of the sensing data of the sensing service as follows:
the first device sends a third message to the second device, where the third message includes a transmission method of sensing data supported by the first device; and the first device obtains a fourth message sent by the second device, where the fourth message includes the transmission method, that is determined by the second device according to the third message, of the sensing data of the sensing service;
or, the first device sends a fifth message to the second device, where the fifth message is used for inquiring whether the second device supports transmitting sensing data through a container; and the first device obtains a sixth message sent by the second device, where the sixth message includes the transmission method, that is determined by the second device according to the fifth message, of the sensing data of the sensing service;
or, the first device sends a seventh message to the second device, where the seventh message is used for request a transmission method of sensing data supported by the second device for the sensing service; the first device obtains an eighth message sent by the second device, where the eighth message includes the transmission method of sensing data supported by the second device for the sensing service; and the first device determines the transmission method of the sensing data of the sensing service according to the eighth message.

Optionally, the implementation further includes:

the first device obtains a ninth message sent by the second device, where the ninth message includes a sensing service performed by the second device or a service identifier corresponding to a sensing service performed by the second device.

The ninth message may be specifically sensing service configuration information.

Optionally, the ninth message further includes at least one of the following:
a sensing measurement that needs to be reported by the first device;
vender information of the second device; or
token information.

Optionally, the first device sends the container to the second device as follows:

the first device sends the container to the second device in a case that the determined transmission method of the sensing data of the sensing service is to transmit sensing data through a container, and the vender information or the token information satisfies a preset condition.

Optionally, the foregoing preset condition includes: a vender of the second device is a vender that is appointed in advance and can transmit the sensing data to the first device through the container, or the token information of the second device is the same as the token information stored or possessed by the first device.

The implementation is described below in combination with an embodiment.

In the embodiment, the first device is an RAN, and the second device is an SF. As shown in FIG. 5, the embodiment includes:

Step 501: An SF receives a command for performing a sensing service requirement and selects an RAN.

The requirement may be an AF trigger, an SF trigger, an RAN trigger, or a UE trigger.

Optionally, the SF may select an RAN according to location information.

Step 502: The SF sends sensing service configuration information to the selected RAN.

The sensing service configuration information includes: a performed sensing service or a service identifier corresponding to a sensing service performed by the second device.

Optionally, the sensing service configuration information further includes at least one of the following:
a sensing measurement to be reported by the RAN;
a vender ID of the SF, that is, vender information of the SF; or
token information of the SF, that is, a token owned by the SF.

Step 503: The RAN sends, for the service, a transmission method of sensing data supported by the RAN to the SF.

For example, the RAN lists all transmission methods of sensing data supported by the RAN. The transmission methods of sensing data supported by the RAN may be sent to the SF through a sensing transmission method request message.

Or, in a case that the RAN determines that the sensing service may be transmitted through the predefined parameter, the RAN inquires whether the SF supports transmitting the sensing data corresponding to the additional sensing measurement through the container.

Or, in a case that the RAN determines that the sensing service does not support transmission through the predefined parameter, the RAN inquires whether to support transmitting the sensing data corresponding to the sensing measurement through the container.

Step 504: The SF sends a determined transmission method of sensing data.

The SF may send, through the sensing transmission method response message, the transmission method of sensing data determined by the SF.

Step 505: The RAN sends a sensing service configuration response message, where the sensing service configuration response message includes an acceptance message or a rejection message.

The acceptance message in the sensing service configuration response message indicates that the RAN agrees on the transmission method of sensing data determined by the SF. The reject message indicates that the RAN does not agree on the transmission method of sensing data determined by the SF.

A subsequent process is the same as Step 406 to Step 408 in the embodiment shown in FIG. 4.

It should be noted that in the embodiment, Step 503 and Step 504 are described by using an example in which the SF finally determines the transmission method of sensing data. Alternatively, the RAN requests the SF for the transmission method of sensing data corresponding to the sensing service supported by the SF, and after the SF sends the transmission method to the RAN, the RAN finally determines the transmission mode of sensing data.

In the method for transmitting data according to the embodiment of the present application, the first device sends the container to the second device. The container includes the sensing data of the sensing service. According to the solution, when an operator or a manufacturer has a customization requirement for a sensing service, sensing data corresponding to the sensing service satisfying the customization requirement can be transmitted through the container.

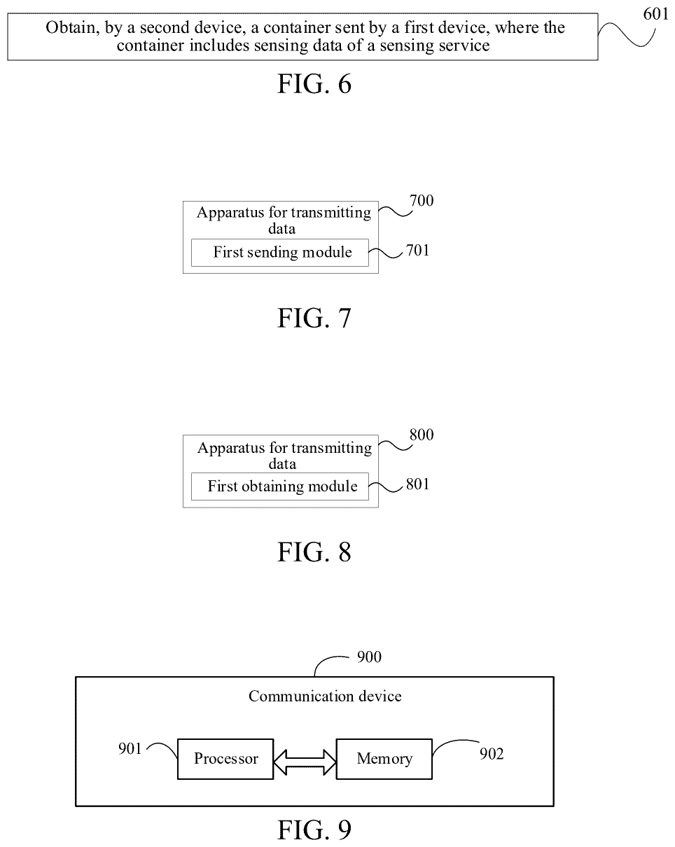

As shown in FIG. 6, an embodiment of the present application further provides a method for transmitting data. The method includes:

Step 601: A second device obtains a container sent by a first device, where the container includes sensing data of a sensing service.

In the embodiment of the present application, the first device is a radio access device, such as a base station. The second device is a sensing function network element device, that is, an SF network element device.

The sensing data is data corresponding to the sensing measurement. For example, when the sensing measurement is a delay, the sensing data is delay data detected by a base station. When the sensing measurement is signal strength, the sensing data is signal strength data.

In the embodiment of the present application, the second device obtains the container sent by the first device. The container includes the sensing data of the sensing service. According to the solution, when an operator or a manufacturer has a customization requirement for a sensing service, sensing data corresponding to the sensing service satisfying the customization requirement can be transmitted through the container.

Optionally, the second device obtains the container sent by the first device, which includes at least one of the following:
the second device obtains an Internet protocol IP packet sent by the first device, where the IP packet includes the container;
the second device obtains a general packet radio service GPRS tunneling protocol GTP packet sent by the first device, where the GTP packet includes the container;
the second device obtains a new radio sensing protocol NRSP packet sent by the first device, where the NRSP packet includes the container; or
the second device obtains a non access stratum NAS message sent by the first device, where the NAS message includes the container.

Optionally, the second device obtains the container sent by the first device as follows:
the second device obtains one container sent by the first device, where one container includes at least two sensing service identifiers and sensing data of a sensing service corresponding to each sensing service identifier;
or, the second device obtains N1 containers and N1 sensing service identifiers sent by the first device, where each of the N1 containers includes sensing data of one sensing service, the N1 sensing service identifiers have a one-to-one correspondence with the N1 containers, and N1 is a positive integer;
or, the second device obtains N2 containers sent by the first device, where each of the N2 containers includes one sensing service identifier and sensing data of a sensing service corresponding to the sensing service identifier, and N2 is a positive integer.

Optionally, the sensing data of the sensing service includes data corresponding to a sensing measurement of the sensing service. The sensing measurement includes a common sensing measurement and an additional sensing measurement; or the sensing measurement of the sensing service includes an additional sensing measurement.

Optionally, in a case that the sensing measurement of the sensing service includes the additional sensing measurement, the method further includes:

the second device obtains, through a predefined parameter, data corresponding to the common sensing measurement of the sensing service and an identifier corresponding to the sensing service sent by the first device.

Optionally, the method in the embodiment of the present application further includes:

the first device negotiates with the second device to determine a transmission method of the sensing data of the sensing service.

The container is sent by the first device to the second device in a case that the determined transmission method of the sensing data of the sensing service is to send sensing data through a container.

Optionally, the first device negotiates with the second device to determine a transmission method of the sensing data of the sensing service as follows:

the second device sends a first message to the first device, where the first message includes a transmission method of sensing data requested or supported by the second device; and

the second device obtains a second message sent by the first device, where the second message includes the transmission method, that is determined by the first device according to the first message, of the sensing data of the sensing service.

Optionally, the first message further includes a sensing service performed by the second device or a service identifier corresponding to a sensing service performed by the second device.

Optionally, in a case that the first message does not include the service identifier corresponding to the sensing service performed by the second device, the second message includes the service identifier corresponding to the sensing service performed by the second device.

Optionally, the second device sends the first message to the first device as follows:
the second device obtains a tenth message sent by the first device; and
the second device sends the first message to the first device according to the tenth message.

The tenth message includes at least one of the following:
a supported sensing service;
a supported sensing measurement; or
a supported sensing data transmission method.

The sensing data transmission method includes: the sensing data is transmitted through a predefined parameter or through a container.

Optionally, the first device negotiates with the second device to determine a transmission method of the sensing data of the sensing service as follows:
the second device obtains a third message sent by the first device, where the third message includes a transmission method of sensing data supported by the first device; and the second device sends a fourth message to the first device, where the fourth message includes the transmission method, that is determined by the second device according to the third message, of the sensing data of the sensing service;
or, the second device obtains a fifth message sent by the first device, where the fifth message is used for inquiring whether the second device supports transmitting sensing data through a container; and the second device sends a sixth message to the first device, where the sixth message includes the transmission method, that is determined by the second device according to the fifth message, of the sensing data of the sensing service;
or, the second device obtains a seventh message sent by the first device, where the seventh message is used for request a transmission method of sensing data supported by the second device for the sensing service; and the second device sends an eighth message to the first device, where the eighth message includes the transmission method of sensing data supported by the second device for the sensing service.

Optionally, the method in the embodiment of the present application further includes:

the second device sends a ninth message to the first device, where the ninth message includes a sensing service performed by the second device or a service identifier corresponding to a sensing service performed by the second device.

It should be noted that the method for transmitting data performed by the second device is a method corresponding to the method for transmitting data performed by the first device. An interaction process between the two methods has been described in detail in the method embodiment on a first device side, and is not repeated herein.

In the embodiment of the present application, the second device obtains the container sent by the first device. The container includes the sensing data of the sensing service. According to the solution, when an operator or a manufacturer has a customization requirement for a sensing service, sensing data corresponding to the sensing service satisfying the customization requirement can be transmitted through the container.

A performance subject for the method for transmitting data according to the embodiments of the present application may be an apparatus for transmitting data. In the embodiment of the present application, the apparatus for transmitting data according to the embodiment of the present application is described with the apparatus for transmitting data performing the method for transmitting data as an example.

As shown in FIG. 7, an embodiment of the present application provides an apparatus 700 for transmitting data, applied to a first device. The apparatus includes:

a first sending module 701 configured to send a container to a second device, where the container includes sensing data of a sensing service.

Optionally, the first sending module is configured to perform at least one of the following:
send an Internet protocol IP packet to the second device, where the IP packet includes the container;
send a general packet radio service GPRS tunneling protocol GTP packet to the second device, where the GTP packet includes the container;
send a new radio sensing protocol NRSP packet to the second device, where the NRSP packet includes the container; or
send a non access stratum NAS message to the second device, where the NAS message includes the container.

Optionally, the first sending module is configured to: send one container to the second device, where one container includes at least two sensing service identifiers and sensing data of a sensing service corresponding to each sensing service identifier;

or, send N1 containers and N1 sensing service identifiers to the second device, where each of the N1 containers includes sensing data of one sensing service, the N1 sensing service identifiers have a one-to-one correspondence with the N1 containers, and N1 is a positive integer;

or, send N2 containers to the second device, where each of the N2 containers includes one sensing service identifier and sensing data of a sensing service corresponding to the sensing service identifier, and N2 is a positive integer.

Optionally, the sensing data of the sensing service includes data corresponding to a sensing measurement of the sensing service. The sensing measurement includes a common sensing measurement and an additional sensing measurement; or the sensing measurement of the sensing service includes an additional sensing measurement.

Optionally, in a case that the sensing measurement of the sensing service includes the additional sensing measurement, the first sending module is further configured to:

send, by the first device, data corresponding to the common sensing measurement of the sensing service and the service identifier corresponding to the sensing service to the second device through a predefined parameter.

Optionally, the first sending module includes:
a negotiation submodule configured to negotiate with the second device to determine a transmission method of the sensing data of the sensing service; and
a first sending submodule configured to send the container to the second device in a case of determining to send the sensing data of the sensing service through the container.

Optionally, the negotiation submodule includes:
a first obtaining submodule configured to obtain a first message sent by the second device, where the first message includes a transmission method of sensing data requested or supported by the second device; and
a second sending submodule configured to send a second message to the second device, where the second message includes the transmission method, that is determined by the first device according to the first message, of the sensing data of the sensing service.

Optionally, the second sending submodule is configured to send the second message to the second device in a case that the first device supports the transmission method of sensing data requested or supported by the second device. The second message is used for indicating that the determined transmission method of the sensing data of the sensing service is the transmission method of sensing data requested or supported by the second device.

Optionally, the first message further includes a sensing service performed by the second device or a service identifier corresponding to a sensing service performed by the second device.

Optionally, in a case that the first message does not include the service identifier corresponding to the sensing service performed by the second device, the second message includes the service identifier corresponding to the sensing service performed by the second device.

Optionally, the apparatus in the embodiment of the present application further includes:

a second sending module configured to send at least one of the following to the second device:

a supported sensing service;
a supported sensing measurement; or
a supported sensing data transmission method.

The sensing data transmission method includes: the sensing data is transmitted through a predefined parameter or through a container.

Optionally, the first message further includes at least one of the following:
a sensing measurement that needs to be reported by the first device;
vender information of the second device; or
token information of the second device.

Optionally, the second sending submodule is configured to send the second message to the second device by the first device in a case that the transmission method of sensing data requested by the second device is to transmit sensing data through a container, and the vender information or the token information satisfies a preset condition.

Optionally, the negotiation submodule is configured to:
sending a third message to the second device, where the third message includes a transmission method of sensing data supported by the first device; and obtain a fourth message sent by the second device, where the fourth message includes the transmission method, that is determined by the second device according to the third message, of the sensing data of the sensing service;
or, send a fifth message to the second device, where the fifth message is used for inquiring whether the second device supports transmitting sensing data through a container; and obtain a sixth message sent by the second device, where the sixth message includes the transmission method, that is determined by the second device according to the fifth message, of the sensing data of the sensing service;
or, send a seventh message to the second device, where the seventh message is used for request a transmission method of sensing data supported by the second device for the sensing service; obtain an eighth message sent by the second device, where the eighth message includes the transmission method of sensing data supported by the second device for the sensing service; and determine the transmission method of the sensing data of the sensing service according to the eighth message.

Optionally, the first sending module further includes:

a second obtaining submodule configured to obtain a ninth message sent by the second device. The ninth message includes a sensing service performed by the second device or a service identifier corresponding to a sensing service performed by the second device.

Optionally, the ninth message further includes at least one of the following:
a sensing measurement that needs to be reported by the first device;
vender information of the second device; or
token information of the second device.

Optionally, the first sending submodule is configured to send the container to the second device by the first device in a case that the determined transmission method of the sensing data of the sensing service is to transmit sensing data through a container, and the vender information or the token information satisfies a preset condition.

Optionally, the first device is a radio access network device or a terminal, and the second device is a sensing function network element device.

In the embodiment of the present application, the first device sends the container to the second device. The container includes the sensing data of the sensing service. According to the solution, when an operator or a manufacturer has a customization requirement for a sensing service, sensing data corresponding to the sensing service satisfying the customization requirement can be transmitted through the container.

As shown in FIG. 8, an embodiment of the present application provides an apparatus 800 for transmitting data, applied to a second device. The apparatus includes:
a first obtaining module 801 configured to obtain a container sent by a first device, where the container includes sensing data of a sensing service.

Optionally, the first obtaining module is configured to perform at least one of the following:
obtain an Internet protocol IP packet sent by the first device, where the IP packet includes the container;
obtain a general packet radio service GPRS tunneling protocol GTP packet sent by the first device, where the GTP packet includes the container;
obtain a new radio sensing protocol NRSP packet sent by the first device, where the NRSP packet includes the container; or
obtain a non-access stratum NAS message sent by the first device, where the NAS message includes the container.

Optionally, the first obtaining module is configured to:
obtain one container sent by the first device, where one container includes at least two sensing service identifiers and sensing data of a sensing service corresponding to each sensing service identifier;
or, obtain N1 containers and N1 sensing service identifiers sent by the first device, where each of the N1 containers includes sensing data of one sensing service, the N1 sensing service identifiers have a one-to-one correspondence with the N1 containers, and N1 is a positive integer;
or, obtain N2 containers sent by the first device, where each of the N2 containers includes one sensing service identifier and sensing data of a sensing service corresponding to the sensing service identifier, and N2 is a positive integer.

Optionally, the sensing data of the sensing service includes data corresponding to a sensing measurement of the sensing service. The sensing measurement includes a common sensing measurement and an additional sensing measurement; or the sensing measurement of the sensing service includes an additional sensing measurement.

Optionally, the apparatus further includes:
a second obtaining module configured to obtain, through a predefined parameter, data corresponding to the common sensing measurement of the sensing service and an identifier corresponding to the sensing service sent by the first device in a case that the sensing measurement of the sensing service includes the additional sensing measurement.

Optionally, the apparatus in the embodiment of the present application further includes:

a negotiation module configured to negotiate with the second device to determine a transmission method of the sensing data of the sensing service.

The container is sent by the first device to the second device in a case that the determined transmission method of the sensing data of the sensing service is to send sensing data through a container.

Optionally, the negotiation module includes:
a transmitting submodule configured to send a first message to the first device, where the first message includes a transmission method of sensing data requested or supported by the second device; and
a third obtaining submodule configured to obtain a second message sent by the first device, where the second message includes the transmission method, that is determined by the first device according to the first message, of the sensing data of the sensing service.

Optionally, the first message further includes a sensing service performed by the second device or a service identifier corresponding to a sensing service performed by the second device.

Optionally, in a case that the first message does not include the service identifier corresponding to the sensing service performed by the second device, the second message includes the service identifier corresponding to the sensing service performed by the second device.

Optionally, the transmitting submodule includes:
a fourth obtaining submodule configured to obtain a tenth message sent by the first device; and
a third sending submodule configured to send the first message to the first device according to the tenth message.

The tenth message includes at least one of the following:
a supported sensing service;
a supported sensing measurement; or
a supported sensing data transmission method.

The sensing data transmission method includes: the sensing data is transmitted through a predefined parameter or through a container.

Optionally, the negotiation module is configured to:
obtain a third message sent by the first device, where the third message includes a transmission method of sensing data supported by the first device; and send a fourth message to the first device, where the fourth message includes the transmission method, that is determined by the second device according to the third message, of the sensing data of the sensing service;
or, obtain a fifth message sent by the first device, where the fifth message is used for inquiring whether the second device supports transmitting sensing data through a container; and send a sixth message to the first device, where the sixth message includes the transmission method, that is determined by the second device according to the fifth message, of the sensing data of the sensing service;
or, obtain a seventh message sent by the first device, where the seventh message is used for request a transmission method of sensing data supported by the second device for the sensing service; and send an eighth message to the first device, where the eighth message includes the transmission method of sensing data supported by the second device for the sensing service.

Optionally, the negotiation module further includes:
a fourth sending submodule configured to send a ninth message to the first device, where the ninth message includes a sensing service performed by the second device or a service identifier corresponding to a sensing service performed by the second device.

In the embodiment of the present application, the second device obtains the container sent by the first device. The container includes the sensing data of the sensing service. According to the solution, when an operator or a manufacturer has a customization requirement for a sensing service, sensing data corresponding to the sensing service satisfying the customization requirement can be transmitted through the container.

The apparatus for transmitting data in the embodiment of the present application may be an electronic device, for example, an electronic device having an operating system, or a component in an electronic device, such as an integrated circuit or a chip. The electronic device may be a terminal, or may be another device other than a terminal. Illustratively, the terminal may include, but is not limited to, the above listed types of the terminal 11, and the another device may be a server, a network attached storage (NAS), or the like. This is not specifically limited in the embodiment of the present application.

The apparatus for transmitting data provided in the embodiment of the present application can implement various processes implemented in the method embodiment illustrated in FIG. 3 to FIG. 6, and the same technical effect is achieved. To avoid repetition, details are omitted herein.

Optionally, as shown in FIG. 9, an embodiment of the present application further provides a communication device 900. The communication device includes a processor 901 and a memory 902. The memory 902 stores a program or instructions runnable on the processor 901. For example, when the communication device 900 is a terminal or a base station, the program or the instructions, when executed by the processor 901, implement various steps of the method embodiment performed by the first device, and the same technical effect can be achieved. When the communication device 900 is an SF, the program or the instructions, when executed by the processor 901, implement various steps of the method embodiment performed by the second device, and the same technical effects can be achieved. To avoid repetition, details are omitted herein.

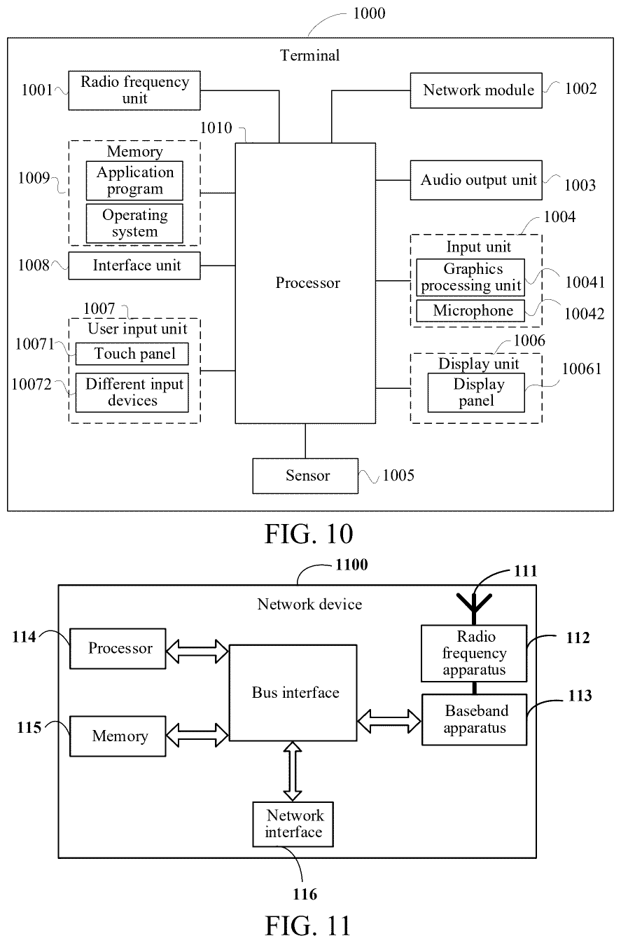

The embodiment of the present application further provides a first device. The first device includes a processor and a communication interface. The communication interface is configured to send a container to the second device. The container includes sensing data of a sensing service. The first device embodiment corresponds to the above first device side method embodiment. Implementation processes and implementations of the above method embodiment are all applicable to the first device embodiment, and the same technical effects can be achieved. Specifically, FIG. 10 is a schematic structural diagram of hardware of a terminal according to an embodiment of the present application.

The terminal 1000 includes, but is not limited to, at least some components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

Those skilled in the art may appreciate that the terminal 1000 may further include a power supply (such as a battery) for supplying power to the components. The power supply may be logically connected to the processor 1010 by a power management system, thereby implementing functions such as charging, discharging, and power consumption management by using the power management system. A terminal structure shown in FIG. 10 does not constitute a limitation on the terminal. The terminal may include more or fewer components than shown, or combine some components, or have different component arrangements, which are not described herein in detail.

It should be understood that in the embodiment of the present application, the input unit 1004 may include a graphics processing unit (GPU) 10041 and a microphone 10042. The graphics processing unit 10041 performs processing on image data of a static picture or a video that is obtained by an image capture device (for example, a camera) in a video capture mode or an image capture mode. The display unit 1006 may include a display panel 10061. The display panel 10061 may be configured in a form of a liquid crystal display, an organic light-emitting, etc. The user input unit 1007 includes at least one of a touch panel 10071 or another input device 10072. The touch panel 10071 is also referred to as a touchscreen. The touch panel 10071 may include two parts of a touch detection apparatus and a touch controller. The another input device 10072 may include, but not limited to, a physical keyboard, a functional key (such as a volume control key or a switch key), a track ball, a mouse, and a joystick, which are not described herein in detail.

In the embodiment of the present application, after receiving downlink data from a network device, the radio frequency unit 1001 may transmit the downlink data to the processor 1010 for processing. Moreover, the radio frequency unit 1001 may send uplink data to the network device. Generally, the radio frequency unit 1001 includes, but is not limited to, an antenna, an amplifier, a transceiver, a coupler, a low noise amplifier, a duplexer, etc.

The memory 1009 may be configured to store a software program or instruction and various data. The memory 1009 may mainly include a first storage area for storing a program or an instruction, and a second storage area for storing data. The first storage area may store an operating system, an application program or an instruction required by at least one function (for example, a sound playback function, and an image display function), etc. Furthermore, the memory 1009 may include a volatile memory or a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchronous link dynamic random access memory (SLDRAM), and a direct Rambus random access memory (DRRAM). The memory 1009 in the embodiment of the present application includes, but is not limited to, these memories and any other suitable types of memories.

The processor 1010 may include one or more processing units. Optionally, the processor 1010 integrates an application processor and a modem processor. The application processor mainly processes operations involving an operating system, a user interface, an application, and the like. The modem processor mainly processes a wireless communication signal, and is, for example, a baseband processor. It can be understood that the modem processor may not be integrated into the processor 1010.

The radio frequency unit 1001 is configured to send a container to a second device. The container includes sensing data of a sensing service.

Optionally, the radio frequency unit 1001 is configured to perform at least one of the following:
send an Internet protocol IP packet to the second device, where the IP packet includes the container;
send a general packet radio service GPRS tunneling protocol GTP packet to the second device, where the GTP packet includes the container;
send a new radio sensing protocol NRSP packet to the second device, where the NRSP packet includes the container; or
send a non-access stratum NAS message to the second device, where the NAS message includes the container.

Optionally, the radio frequency unit 1001 is configured to:
send one container to the second device, where one container includes at least two sensing service identifiers and sensing data of a sensing service corresponding to each sensing service identifier;
or, send N1 containers and N1 sensing service identifiers to the second device, where each of the N1 containers includes sensing data of one sensing service, the N1 sensing service identifiers have a one-to-one correspondence with the N1 containers, and N1 is a positive integer;
or, send N2 containers to the second device, where each of the N2 containers includes one sensing service identifier and sensing data of a sensing service corresponding to the sensing service identifier, and N2 is a positive integer.

Optionally, the sensing data of the sensing service includes data corresponding to a sensing measurement of the sensing service. The sensing measurement includes a common sensing measurement and an additional sensing measurement; or the sensing measurement of the sensing service includes an additional sensing measurement.

Optionally, in a case that the sensing measurement of the sensing service includes the additional sensing measurement, the radio frequency unit 1001 is further configured to:

send data corresponding to the common sensing measurement of the sensing service and the service identifier corresponding to the sensing service to the second device through a predefined parameter.

Optionally, the radio frequency unit 1001 is configured to: negotiate with the second device to determine a transmission method of sensing data of the sensing service; and send the container to the second device in a case of determining to send the sensing data of the sensing service through the container.

Optionally, the radio frequency unit 1001 is configured to: obtain a first message sent by the second device, where the first message includes a transmission method of sensing data requested or supported by the second device; and send a second message to the second device, where the second message includes the transmission method, that is determined by the first device according to the first message, of the sensing data of the sensing service.

Optionally, the radio frequency unit 1001 is configured to send the second message to the second device in a case that the first device supports the transmission method of sensing data requested or supported by the second device. The second message is used for indicating that the determined transmission method of the sensing data of the sensing service is the transmission method of sensing data requested or supported by the second device.

Optionally, the first message further includes a sensing service performed by the second device or a service identifier corresponding to a sensing service performed by the second device.

Optionally, in a case that the first message does not include the service identifier corresponding to the sensing service performed by the second device, the second message includes the service identifier corresponding to the sensing service performed by the second device.

Optionally, the radio frequency unit 1001 is configured to send at least one of the following to the second device:

a supported sensing service; a supported sensing measurement; or a supported sensing data transmission method.

The sensing data transmission method includes: the sensing data is transmitted through a predefined parameter or through a container.

Optionally, the first message further includes at least one of the following:

a sensing measurement that needs to be reported by the first device; vender information of the second device; or token information of the second device.

Optionally, the radio frequency unit 1001 is configured to send the second message to the second device in a case that the transmission method of sensing data requested by the second device is to transmit sensing data through a container, and the vender information or the token information satisfies a preset condition.

Optionally, the radio frequency unit 1001 is configured to: send a third message to the second device, where the third message includes a transmission method of sensing data supported by the first device; and obtain a fourth message sent by the second device, where the fourth message includes the transmission method, that is determined by the second device according to the third message, of the sensing data of the sensing service;

or, send a fifth message to the second device, where the fifth message is used for inquiring whether the second device supports transmitting sensing data through a container; and obtain a sixth message sent by the second device, where the sixth message includes the transmission method, that is determined by the second device according to the fifth message, of the sensing data of the sensing service;

or, send a seventh message to the second device, where the seventh message is used for request a transmission method of sensing data supported by the second device for the sensing service; obtain an eighth message sent by the second device, where the eighth message includes the transmission method of sensing data supported by the second device for the sensing service; and determine the transmission method of the sensing data of the sensing service by the first device according to the eighth message.

Optionally, the radio frequency unit 1001 is configured to obtain a ninth message sent by the second device. The ninth message includes a sensing service performed by the second device or a service identifier corresponding to a sensing service performed by the second device.

Optionally, the ninth message further includes at least one of the following:

a sensing measurement that needs to be reported by the first device; vender information of the second device; or token information of the second device.

Optionally, the radio frequency unit 1001 is configured to send the container to the second device in a case that the determined transmission method of the sensing data of the sensing service is to transmit sensing data through a container, and the vender information or the token information satisfies a preset condition.

Optionally, the second device is a sensing function network element device.

In the embodiment of the present application, the container is sent to the second device. The container includes the sensing data of the sensing service. According to the solution, when an operator or a manufacturer has a customization requirement for a sensing service, sensing data corresponding to the sensing service satisfying the customization requirement can be transmitted through the container.

The embodiment of the present application further provides a network device. The network device includes a processor and a communication interface. The communication interface is configured to: send the container to the second device, where the container includes the sensing data of the sensing service; or obtain the container sent by the first device, where the container includes the sensing data of the sensing service. The network device embodiment corresponds to the foregoing first device or second device method embodiment. The implementation processes and implementations of the foregoing method embodiments are all applicable to the network device embodiment, and the same technical effects can be achieved.

Specifically, an embodiment of the present application further provides a network device. As shown in FIG. 11, the network device 1100 includes an antenna 111, a radio frequency apparatus 112, a baseband apparatus 113, a processor 114, and a memory 115. The antenna 111 is connected to the radio frequency apparatus 112. In an uplink direction, the radio frequency apparatus 112 receives information through the antenna 111, and sends the received information to the baseband apparatus 113 for processing. In a downlink direction, the baseband apparatus 113 processes to-be-sent information, and sends the processed information to the radio frequency apparatus 112. The radio frequency apparatus 112 processes the received information and then sends the processed information through the antenna 111.

The method performed by the first device in the foregoing embodiment may be implemented in the baseband apparatus 113. The baseband apparatus 113 includes a baseband processor.

The baseband apparatus 113 may include, for example, at least one baseband board. A plurality of chips are disposed on the baseband board. As shown in FIG. 11, one of the chips is, for example, the baseband processor which is connected to the memory 115 through a bus interface to call a program in the memory 115, to perform the operations of the first device shown in the foregoing method embodiments.

The network device may further include a network interface 116. The interface is, for example, a common public radio interface (CPRI).

Specifically, the network device 1100 in the embodiment of the present application further includes: instructions or a program stored in the memory 115 and executable on the processor 114. The processor 114 calls the instructions or the program in the memory 115 to perform the method performed by each module shown in FIG. 7, and the same technical effects are achieved. To avoid repetition, details are omitted herein.

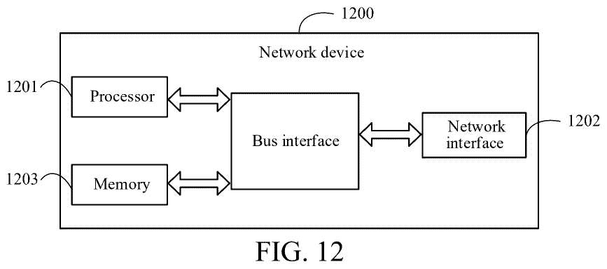

Specifically, an embodiment of the present application further provides a network device. As shown in FIG. 12, the network device 1200 includes a processor 1201, a network interface 1202, and a memory 1203. The network interface 1202 is, for example, a common public radio interface (CPRI).

Specifically, the network device 1200 in the embodiment of the present application further includes: instructions or a program stored in the memory 1203 and executable on the processor 1201. The processor 1201 calls the instructions or the program in the memory 1203 to perform the method performed by each module shown in FIG. 8, and the same technical effects are achieved. To avoid repetition, details are omitted herein.

An embodiment of the present application further provides a readable storage medium. The readable storage medium stores a program or instructions. The program or instructions, when executed by a processor, implement various processes of the embodiment of the method for transmitting data, and the same technical effects can be achieved. To avoid repetition, details are omitted herein.

The processor is the processor in the terminal described in the above embodiment. The readable storage medium includes a computer-readable storage medium, such as a computer read-only memory ROM, a random access memory RAM, a magnetic disk, or an optical disc. In some examples, the readable storage medium may be a non-transitory readable storage medium.

An embodiment of the present application further provides a chip. The chip includes a processor and a communication interface. The communication interface is coupled to the processor. The processor is configured to run a program or instructions, to implement the processes of the embodiment of the method for transmitting data, and the same technical effects can be achieved. To avoid repetition, details are omitted herein.

It should be understood that the chip mentioned in the embodiment of the present application may alternatively be referred to as a system-level chip, a system chip, a chip system, a system-on-chip, or the like.

An embodiment of the present application further provides a computer program/program product. The computer program/program product is stored in a storage medium. The computer program/program product is executed by at least one processor, to implement the foregoing processes in embodiments of the method for transmitting data, and the same technical effects can be achieved. To avoid repetition, details are omitted herein.

The embodiment of the present application further provides a system for transmitting data. The system includes a first device and a second device. The first device may be configured to perform steps of the method on a first device side. The second device may be configured to perform steps of the method on a second device side.

It should be noted herein that the terms “comprise”, “include”, or their any other variations are intended to cover non-exclusive inclusion. Therefore, a process, method, product, or apparatus including a series of elements further includes other elements that are not explicitly listed except for those elements, or further includes elements inherent to such a process, method, product, or apparatus. Without more limitations, an element defined by a sentence “comprise a . . . ” or and “include a . . . ” does not exclude existence of other same elements in the process, the method, the object, or the apparatus that includes the element. Moreover, it should be noted that the scope of the method and the apparatus in the implementations of the present application is not limited to function execution in the order shown or discussed, and may further include function execution in a substantially simultaneous manner or in an opposite order according to the functions. For example, the described method may be performed in an order different from the described order, and various steps may further be added, omitted, or combined. Furthermore, features described with reference to some examples may be combined in other examples.

Through the description of the foregoing implementations, those skilled in the art can clearly understand that the methods according to the foregoing embodiments may be implemented by a computer software product and a necessary general hardware platform, and certainly, may alternatively be implemented by hardware. The computer software product is stored in a storage medium (such as an ROM/RAM, a magnetic disk, or an optical disc) and includes several instructions for instructing a terminal or a network device to perform the methods described in the embodiments of the present application.

The embodiments of the present application are described above with reference to the accompanying drawings. However, the present application is not limited to the specific implementations described above, and the specific implementations described above are merely illustrative and not limitative. Those of ordinary skill in the art may make implementations with various variations under the teaching of the present application without departing from the spirit of the present application and the protection scope of the claims, and such implementations shall all fall within the protection scope of this application.

What is claimed is:

1. A method for transmitting data, comprising:
sending a container to a second device by a first device, wherein the container comprises sensing data of a sensing service.

2. The method according to claim 1, wherein the sending a container to a second device by a first device comprises at least one of the following:
sending an Internet protocol (IP) packet to the second device by the first device, wherein the IP packet comprises the container;
sending a general packet radio service (GPRS) tunneling protocol (GTP) packet to the second device by the first device, wherein the GTP packet comprises the container;
sending a new radio sensing protocol (NRSP) packet to the second device by the first device, wherein the NRSP packet comprises the container; or
sending a non-access stratum (NAS) message to the second device by the first device, wherein the NAS message comprises the container.

3. The method according to claim 1, wherein the sending a container to a second device by a first device comprises:
sending one container to the second device by the first device, wherein one container comprises at least two sensing service identifiers and sensing data of a sensing service corresponding to each sensing service identifier;
or, sending N1 containers and N1 sensing service identifiers to the second device by the first device, wherein each of the N1 containers comprises sensing data of one sensing service, the N1 sensing service identifiers have a one-to-one correspondence with the N1 containers, and N1 is a positive integer;
or, sending N2 containers to the second device by the first device, wherein each of the N2 containers comprises one sensing service identifier and sensing data of a sensing service corresponding to the sensing service identifier, and N2 is a positive integer.

4. The method according to claim 1, wherein the sensing data of the sensing service comprises data corresponding to a sensing measurement of the sensing service, and the sensing measurement comprises a common sensing measurement and an additional sensing measurement; or the sensing measurement of the sensing service comprises an additional sensing measurement;
wherein when the sensing measurement of the sensing service comprises the additional sensing measurement, the method further comprises:
sending, by the first device, data corresponding to the common sensing measurement of the sensing service and the service identifier corresponding to the sensing service to the second device through a predefined parameter.

5. The method according to claim 1, wherein the sending a container to a second device by a first device comprises:
negotiating with the second device by the first device to determine a transmission method of the sensing data of the sensing service; and
sending the container to the second device by the first device when determining to send the sensing data of the sensing service through the container;
wherein the negotiating with the second device by the first device to determine a transmission method of the sensing data of the sensing service comprises:
obtaining, by the first device, a first message sent by the second device, wherein the first message comprises a transmission method of sensing data requested or supported by the second device; and
sending a second message to the second device by the first device, wherein the second message comprises the transmission method, that is determined by the first device according to the first message, of the sensing data of the sensing service.

6. The method according to claim 5, wherein the sending a second message to the second device by the first device comprises:
sending the second message to the second device when the first device supports the transmission method of sensing data requested or supported by the second device, wherein the second message is used for indicating that the determined transmission method of the sensing data of the sensing service is the transmission method of sensing data requested or supported by the second device.

7. The method according to claim 5, wherein the first message further comprises a sensing service performed by the second device or a service identifier corresponding to a sensing service performed by the second device;
wherein when the first message does not comprise the service identifier corresponding to the sensing service performed by the second device, the second message comprises the service identifier corresponding to the sensing service performed by the second device.

8. The method according to claim 5, further comprising:
sending at least one of the following to the second device by the first device:
a supported sensing service;
a supported sensing measurement; or
a supported sensing data transmission method, wherein the sensing data transmission method comprises: transmitting the sensing data through a predefined parameter or transmitting the sensing data through a container.

9. The method according to claim 5, wherein the first message comprises at least one of the following:
a sensing measurement that needs to be reported by the first device;
vender information of the second device; or
token information of the second device;
wherein the sending a second message to the second device by the first device comprises:
sending the second message to the second device by the first device when the transmission method of sensing data requested by the second device is to transmit sensing data through a container, and the vender information or the token information satisfies a preset condition.

10. The method according to claim 5, wherein the negotiating with the second device by the first device to determine a transmission method of the sensing data of the sensing service comprises:
sending a third message to the second device by the first device, wherein the third message comprises a transmission method of sensing data supported by the first device; and obtaining, by the first device, a fourth message sent by the second device, wherein the fourth message comprises the transmission method, that is determined by the second device according to the third message, of the sensing data of the sensing service;
or, sending a fifth message to the second device by the first device, wherein the fifth message is used for inquiring whether the second device supports transmitting sensing data through a container; and obtaining, by the first device, a sixth message sent by the second device, wherein the sixth message comprises the transmission method, that is determined by the second device according to the fifth message, of the sensing data of the sensing service;
or, sending a seventh message to the second device by the first device, wherein the seventh message is used for request a transmission method of sensing data supported by the second device for the sensing service; obtaining, by the first device, an eighth message sent by the second device, wherein the eighth message comprises the transmission method of sensing data supported by the second device for the sensing service; and determining the transmission method of the sensing data of the sensing service according to the eighth message by the first device;
the method further comprises:
obtaining, by the first device, a ninth message sent by the second device, wherein the ninth message comprises a sensing service performed by the second device or a service identifier corresponding to a sensing service performed by the second device;
wherein the ninth message further comprises at least one of the following:
a sensing measurement that needs to be reported by the first device;
vender information of the second device; or
token information of the second device;
wherein the sending the container to the second device by the first device comprises:
sending the container to the second device by the first device when the determined transmission method of the sensing data of the sensing service is to transmit sensing data through a container, and the vender information or the token information satisfies a preset condition.

11. A method for transmitting data, comprising:
obtaining, by a second device, a container sent by a first device, wherein the container comprises sensing data of a sensing service.

12. The method according to claim 11, wherein the obtaining, by a second device, a container sent by a first device comprises at least one of the following:
obtaining, by the second device, an Internet protocol (IP) packet sent by the first device, wherein the IP packet comprises the container;
obtaining, by the second device, a general packet radio service (GPRS) tunneling protocol (GTP) packet sent by the first device, wherein the GTP packet comprises the container;
obtaining, by the second device, a new radio sensing protocol (NRSP) packet sent by the first device, wherein the NRSP packet comprises the container; or
obtaining, by the second device, a non-access stratum (NAS) message sent by the first device, wherein the NAS message comprises the container.

13. The method according to claim 11, wherein the obtaining, by a second device, a container sent by a first device comprises:
obtaining, by the second device, one container sent by the first device, wherein one container comprises at least two sensing service identifiers and sensing data of a sensing service corresponding to each sensing service identifier;
or, obtaining, by the second device, N1 containers and N1 sensing service identifiers sent by the first device, wherein each of the N1 containers comprises sensing data of one sensing service, the N1 sensing service identifiers have a one-to-one correspondence with the N1 containers, and N1 is a positive integer;
or, obtaining, by the second device, N2 containers sent by the first device, wherein each of the N2 containers comprises one sensing service identifier and sensing data of a sensing service corresponding to the sensing service identifier, and N2 is a positive integer.

14. The method according to claim 11, wherein the sensing data of the sensing service comprises data corresponding to a sensing measurement of the sensing service, and the sensing measurement comprises a common sensing measurement and an additional sensing measurement; or the sensing measurement of the sensing service comprises an additional sensing measurement;
wherein when the sensing measurement of the sensing service comprises the additional sensing measurement, the method further comprises:
obtaining, by the second device through a predefined parameter, data corresponding to the common sensing measurement of the sensing service and an identifier corresponding to the sensing service sent by the first device.

15. The method according to claim 11, further comprising:
negotiating with the second device by the first device to determine a transmission method of the sensing data of the sensing service, wherein
the container is sent by the first device to the second device when the determined transmission method of the sensing data of the sensing service is to send sensing data through a container;
wherein the negotiating with the second device by the first device to determine a transmission method of the sensing data of the sensing service comprises:
sending a first message to the first device by the second device, wherein the first message comprises a transmission method of sensing data requested or supported by the second device; and
obtaining, by the second device, a second message sent by the first device, wherein the second message comprises the transmission method, that is determined by the first device according to the first message, of the sensing data of the sensing service.

16. The method according to claim 15, wherein the first message further comprises a sensing service performed by the second device or a service identifier corresponding to a sensing service performed by the second device;
wherein when the first message does not comprise the service identifier corresponding to the sensing service performed by the second device, the second message comprises the service identifier corresponding to the sensing service performed by the second device.

17. The method according to claim 16, where the sending a first message to the first device by the second device comprises:
obtaining, by the second device, a tenth message sent by the first device; and
sending the first message to the first device by the second device according to the tenth message, wherein
the tenth message comprises at least one of the following:
a supported sensing service;
a supported sensing measurement; or
a supported sensing data transmission method, wherein
the sensing data transmission method comprises: transmitting the sensing data through a predefined parameter or transmitting the sensing data through a container.

18. The method according to claim 15, wherein the negotiating with the second device by the first device to determine a transmission method of the sensing data of the sensing service comprises:
obtaining, by the second device, a third message sent by the first device, wherein the third message comprises a transmission method of sensing data supported by the first device; and
sending a fourth message to the first device by the second device, wherein the fourth message comprises the transmission method, that is determined by the second device according to the third message, of the sensing data of the sensing service;
or, obtaining, by the second device, a fifth message sent by the first device, wherein the fifth message is used for inquiring whether the second device supports transmitting sensing data through a container; and sending a sixth message to the first device by the second device, wherein the sixth message comprises the transmission method, that is determined by the second device according to the fifth message, of the sensing data of the sensing service;
or, obtaining, by the second device, a seventh message sent by the first device, wherein the seventh message is used for request a transmission method of sensing data supported by the second device for the sensing service; and sending an eighth message to the first device by the second device, wherein the eighth message comprises the transmission method of sensing data supported by the second device for the sensing service;
the method further comprises:
sending a ninth message to the first device by the second device, wherein the ninth message comprises a sensing service performed by the second device or a service identifier corresponding to a sensing service performed by the second device.

19. A communication device, wherein the communication device is a first device, comprising a processor and a memory, wherein the memory stores a program or instructions runnable on the processor, wherein the program or the instructions, when executed by the processor, cause the first device to perform:
sending a container to a second device, wherein the container comprises sensing data of a sensing service.

20. The communication device according to claim 19, wherein when sending a container to a second device, the program or the instructions, when executed by the processor, cause the communication device to perform at least one of the following:
sending an Internet protocol (IP) packet to the second device, wherein the IP packet comprises the container;
sending a general packet radio service (GPRS) tunneling protocol (GTP) packet to the second device, wherein the GTP packet comprises the container;
sending a new radio sensing protocol (NRSP) packet to the second device, wherein the NRSP packet comprises the container; or
sending a non-access stratum (NAS) message to the second device, wherein the NAS message comprises the container.
